(19) United States
(12) Patent Application Publication
(10) Pub. No.: US 2018/0294759 A1
(43) Pub. Date: Oct. 11, 2018

(54) METHOD FOR CONTROLLING AN ELECTRIC FAN

(71) Applicant: SPAL AUTOMOTIVE S.r.l., Correggio (RE) (IT)

(72) Inventor: Pietro DE FILIPPIS, Varazze (IT)

(73) Assignee: SPAL AUTOMOTIVE S.r.l., Correggio (RE) (IT)

(21) Appl. No.: 15/766,660

(22) PCT Filed: Oct. 28, 2016
(86) PCT No.: PCT/IB2016/056503

§ 371 Date: Apr. 6, 2018

(30) Foreign Application Priority Data
Oct. 30, 2015 (IT) 102015000067601

(51) Int. Cl. H02P 27/04; H02P 29/68; H02P 3/18; G05D 23/24

(52) U.S. Cl. CPC H02P 27/04; H02P 29/68; H02M 2001/0003; G05D 23/2451; H02P 3/18

(57) ABSTRACT

A method for controlling an electric fan including an electric motor and electronics for controlling the electric motor, including a step for controlling the speed of the motor, a step for controlling the power of the motor as an alternative to the step for controlling the speed; the step for controlling the power including a step for monitoring the electrical power P_{IN;FEEDBACK} absorbed by the motor and a step for regulating the electrical power P_{IN;FEEDBACK} absorbed by the motor including a step of applying a variation Δfreq to the electricity supply frequency of the motor as a function of a difference between a power set-point PI_{IN, REF} and the power absorbed by the motor PI_{IN,FEEDBACK}.

### TECHNICAL FIELD

This invention relates to a method for controlling an electric fan and in particular a method for controlling the electric motor of an electric fan in automotive applications.

### BACKGROUND ART

Electric fans are widely used in the automotive sector with functions of cooling and removing heat from radiating masses, that is, for cooling heat exchangers, for example radiators, for cooling motors (engine-cooling), radiators for air conditioning, radiators for cooling oil (oil-cooling).

The electric fans comprise, in short, an electric motor, electronics for controlling the motor and a fan driven by the motor which defines the entire system or drive.

A distinctive feature of the control electronics is also the possibility of protecting the electric motor and the electronics from any overheating or over-temperatures, determined, for example, by particularly severe operating conditions, such as a high ambient temperature or sudden drawbacks.

More specifically, the overheatings are delicate in electric fans comprising electric motors of the closed and/or sealed type with control electronics fitted inside, in which the heat dissipation is of even greater importance and must be significantly reduced.

In general, the electric fan and the control electronics are characterised by precise temperature ranges wherein the operation is optimum and safe and the nominal performance is guaranteed.

If there is a temperature increase in the motor above the permissible maximum values, even though it is operating at nominal values, it is necessary to intervene in order to protect the control electronics, especially the electronic components, against possible damage.

One control strategy comprises, in the case of temperature increases beyond the permissible values, “degrading” the motor, that is to say, reducing the efficiency and power outputs compared with the nominal performance levels, which are no longer guaranteed, in order to preserve the control electronics.

The degrading, also known as “thermal derating” is used, in practice, to lower the working temperature of the motor in order to counteract, for example, an increase in the outside temperature.

As part of the scenario, one of the design requirements of any derating method must be to ensure the maximum availability of the electric fan to operate at temperatures as close as possible to the limit values permitted by the specifications of the components used.

The most state-of-the-art control processes currently available for protection against over-temperatures, which receive feedback from one or more temperature sensors inside the drive, react to an overheating of the drive itself, in particular of the electronic board, reducing the speed of rotation of the motor controlled.

These processes attempt to lower the operating temperature, temporarily limiting the performance, that is, the speed of rotation of the motor.

This type of derating may, however, be excessive, since the direct reduction of the speed of the motor does not consider how much the absorbed electrical power is actually varying, and this fact translates nearly always into an over-protection of the drive.

Whilst, on the one hand, a similar approach favours the protection of the electric fan from potential breakage due to excess over-temperature of its components, on the other hand, the associated consequent reduction of performance could induce problems of overheating of the heat exchangers: in other words, the user could risk damage whilst the electric fan would be over-protected.

In general, the drive comprises, amongst the other electronic components, a microcontroller and a plurality of electronic power components, such as, for example, MOSFETs.

A known control method comprises monitoring the temperature of the microcontroller, or the board on which it is installed, and the power MOSFETs; if the temperature of the MOSFETs reaches a respective maximum threshold temperature, the motor is stopped.

With reference to FIGS. 1A and 1B, relating to this known control method, considering the temperature of the microcontroller, starting from a working condition at the nominal speed Vₙ, if the temperature of the microcontroller T_{micro} reaches a respective first threshold temperature T_{der} a process is activated for degrading the performance of the electric fan with a corresponding reduction in the speed of the motor, for example with a proportional error at ΔT, up to a value Vₘᵢₙ beyond which the electric fan continues to rotate at a extremely reduced constant speed compared with the nominal speed.

If the temperature of the microcontroller continuous to rise, despite the degrading, to a second threshold temperature Tₘₐₓ, the motor is stopped and the speed is changed to 0.

In practice, the degrading is controlled by a regulating device, for example PI, based on the temperature error; in the case, not illustrated, in which the temperature of the microcontroller drops again below T_{der} before the motor stops, the speed is again increased to Vₙ.

The main drawback of this control and protection method is that, as mentioned, under certain conditions, the speed of rotation of the electric fan might be excessively reduced, placing at risk the entire vehicle on which the electric fan is installed, in cases in which the over-temperature is caused by a transient event which passes in a relatively short time.

In this context, the main aim of this invention is to overcome the above-mentioned drawback.

### DISCLOSURE OF THE INVENTION

The aim of this invention is to propose a method for controlling an electric fan which increases the safety of the entire vehicle, avoiding a degrading or even a too sudden switching off of the electric fan.

A further aim of this invention is to propose a control method which allows the electric fan to provide the maximum performance at temperatures compatible with physical limits of the components used, without using, in practice, excessive protection.

The technical purpose indicated and at least the aims specified are substantially achieved by a control method according to claim 1.

### BRIEF DESCRIPTION OF DRAWINGS

Further features and advantages of this invention are more apparent in the detailed description below, with reference to a preferred, non-restricting, embodiment of a control method for an electric fan as schematically illustrated in the accompanying drawings, in which:

FIG. 1A illustrates an example of the temperature diagram of the microcontroller as a function of time in a control method of known type;

FIG. 1B illustrates a diagram of the rotation speed of the motor as a function of time correlated with the diagram of FIG. 1A of the control method of known type;

FIG. 2 illustrates a finished state machine which describes the control method according to this invention;

FIG. 3 illustrates a diagram of a system regulator for adjusting the temperature in the drive in a preferred embodiment of this invention;

FIG. 4 illustrates an example of the trend of a reference quantity as a function of reading time in the diagram of FIG. 3.

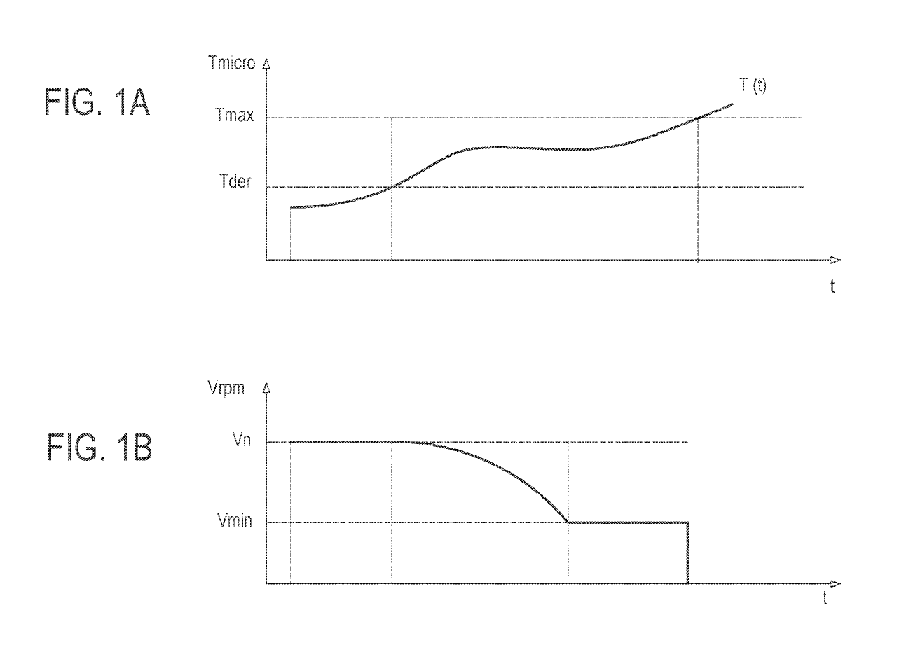

### DETAILED DESCRIPTION OF PREFERRED EMBODIMENTS OF THE INVENTION

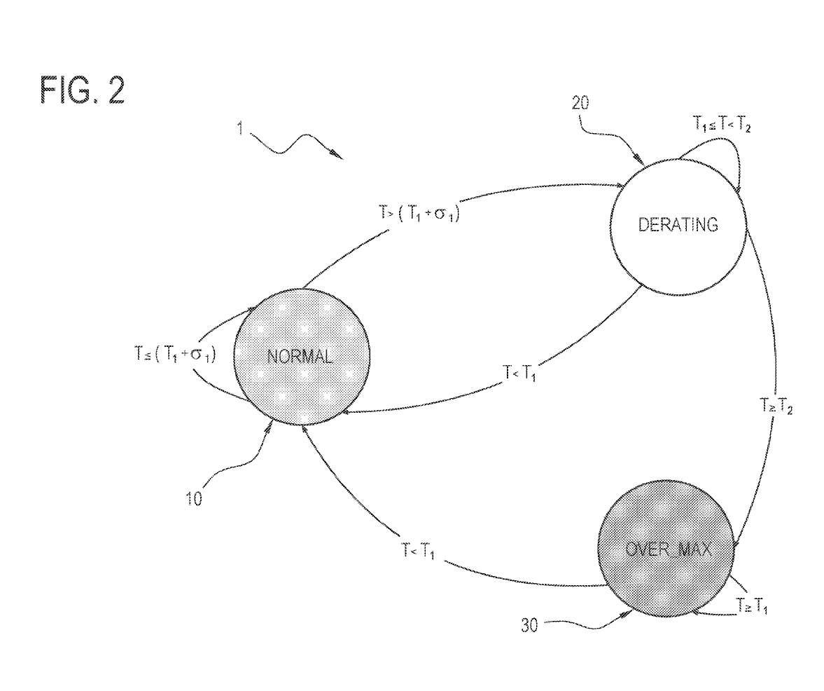

With reference to FIG. 2, the numeral 1 denotes a finished state machine based which describes, in general terms, the method for controlling an electric fan.

The electric fan of the substantially known type and not illustrated preferably controlled according to this method comprises, very briefly, an electric motor, a fan driven by the electric motor and an electric or electronic board for driving and controlling the electric motor.

The electronic board is preferably housed inside the motor which in turn is preferably of the sealed type.

More specifically, by way of a non-limiting example, reference is made below to an actuator comprising an electronic system which commands and controls a three-phase brushless sinusoidal motor with permanent magnets, which in turn drives a ventilation unit (fan and conveyor) aimed at cooling groups of heat exchangers in automotive applications.

The electronic board comprises a microcontroller and electronic power means which comprise, for example and preferably, MOSFETs, to which explicit reference will be made, for controlling and powering the electric motor.

The microcontroller has a relative temperature T_{D} and the MOSFETs have a relative temperature T_{M}.

With reference to FIG. 2, in terms of state-based logic, this method comprises three operating states of the electric fan.

In a first state, referred to as NORMAL and denoted by the numeral 10, the electric fan operates under nominal operating conditions until

T≤(T₁+δ₁)

where:
T is the temperature measured on the electronic board.

T is, for example, the temperature of the microcontroller or the temperature of the MOSFET both monitored, that is, T=T_{D} or T_{M};

T₁ is the maximum nominal operating temperature of the electronic board.

T₁ is, for example, the maximum nominal operating temperature of the microcontroller or the maximum nominal operating temperature of the MOSFET.

δ₁ is a hysteresis on the maximum nominal operating temperature beyond which it changes to thermal derating.

The hysteresis is needed in order to not to unnecessarily activate the control method described in detail below, if there are only temperature oscillations close to the threshold T₁, or, for example, the measurement T is affected by measuring noise.

When T>(T₁+δ₁) changes to a second state, referred to as DERATING and denoted by the numeral 20.

In the DERATING state the electrical power of the drive is controlled is in such a way as to reduce the temperature and adjust it to the value T₁ shown above, as described in detail below.

The DERATING state defines, in practice, a step for regulating the temperature T of the control electronics.

In practice, a error in the temperature measured at the electronic board determines a regulation of the electrical power absorbed by the electric fan, in particular by the motor.

The DERATING state is kept until T₁≤T<T₂.

T2 is the threshold operating temperature of the electronic board.

T₂ is, for example, the maximum permissible temperature of the microcontroller or the maximum permissible temperature of the MOSFET.

T obviously feels the effect of the ambient temperature in which the electric fan is operating.

Starting from the DERATING state if, for example due to a decrease in the ambient temperature, the temperature measured on the electronic board falls below the maximum nominal operating temperature, that is, T<T₁, the electric fan returns gradually, preferably in the manner described below, to the nominal operation, the NORMAL state.

Starting from the DERATING state, if, on the other hand, due to an excessive overheating, the temperature measured on the electronic board exceeds the operational threshold of the electronic board, that is, T≥T₂ it changes to a third state known as OVER_MAX and labelled 30.

This state interrupts the operation the electric fan until T≥T₁.

When this condition becomes false (i.e. T<T₁), the system returns to the NORMAL state and the electric fan can again operate normally.

Preferably, under normal operating conditions, the electric fan is controlled by speed (speed-control) by means of a suitable speed set-point, in a substantially known manner.

An appropriate command not described informs the drive of the need to pass to the above-mentioned power control. This command is, for example, imparted by a control unit of the vehicle in which the electric fan is installed. For example, the change to the power control takes place when the electric fan stops working under nominal conditions.

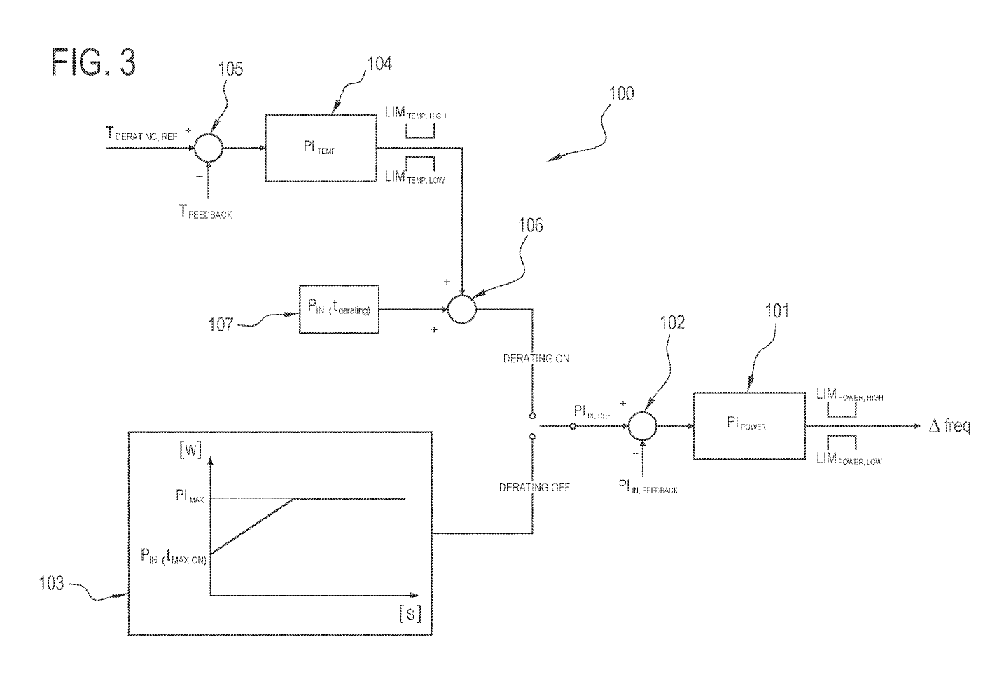

With reference to FIG. 3, the numeral 100 denotes a system regulator for regulating the temperature T of the electronic board by controlling the power absorbed by the motor.

In the example embodiment illustrated, the system 100 comprises a first proportional-integral regulator PI_{POWER} denoted by the numeral 101.

The regulator 101 is configured to control the power absorbed by the electric motor to a predetermined value, producing a consequent variation Δfreq of the electricity supply frequency of the motor.

The regulator 101 has at the input a power set-point P_{IN,REF} and a direct reading of the power absorbed by the motor PI_{IN, FEEDBACK} and provides a contribution in terms of Δ_{freq}.

The power set-point P_{IN,REF} and the value PI_{IN, FEEDBACK} add algebraically in an adder node 102 at the output of which a power error is available:

P_{IN,REF}−PI_{IN,FEEDBACK}

A set-point of this regulator 101, under nominal conditions, that is, in the above-mentioned NORMAL state, that is, in DERATING OFF, as indicated in FIG. 3, comes from a reference generator P_{IN,REF}, denoted by the reference numeral 103.

The generator 103 provides a reference signal in order to change from a current power value P_{IN}(t_{PMAX,ON}) to a desired value P_{MAX}.

The ramp which starts from P_{IN}(t_{PMAX,ON}) is considered by the actuation from when the control unit commands the change to power control from speed control.

The electric fan is in practice controlled in a constant power operational mode; the electrical power absorbed by the motor is the quantity adjusted and the variation of the speed of rotation of the motor is, in practice, a consequence.

The regulator 101 preferably has the output limited to the following limiting values:

LIM_{POWER,HIGH}: maximum output value, set by default to the difference between a maximum regulating frequency in power control P_{MAX}, EIFreq_{MAX}, and a maximum frequency in speed control, EIFreq_{NEN};

LIM_{POWER,LOW}: minimum output value, set by default to 0; in that way, when in power control, PI_{Power} keeps the power of the motor at P_{MAX} by varying the electrical frequency between EIFreq_{NEN} and EIFreq_{MAX}, that is, in terms of ‘delta-frequency’:

0≤Δfreq≤(EIFreq_{MAX}−EIfreq_{NEN}).

In practice:

LIM_{POWER,HIGH}=EIFreq_{MAX}−EIFreq_{NEN};

LIM_{POWER,LOW}=0 if derating OFF;

LIM_{POWER,LOW}=−(EIFreq_{MAX}−EIFreq_{MIN}) if derating ON.

Until PI_{IN, FEEDBACK} remains less than P_{IN,REF}, Δfreq is positive, determining an acceleration of the motor.

When PI_{IN, FEEDBACK}=P_{IN,REF} the regulator stops accelerating the motor.

In the case of thermal derating, DERATING ON, with reference to FIG. 3, in order to have, in practice, a negative contribution to Δfreq and reduce the power absorbed by the motor and therefore its speed of rotation, the regulator 101 PI_{POWER} is controlled by a proportional-integral regulator PI_{TEMP}, denoted by the reference numeral 104.

The regulator 104 is preferably substantially similar to the regulator 101.

The regulator 104 reduces, with a relative dynamic, the power set-point PI_{IN,REF} starting from an initial derating value P_{IN}(t_{DERATING}).

The regulator 104 has at the input, by means of an adder node 105, a temperature error T_{DERATING,REF}−T_{FEEDBACK} where:

T_{DERATING, REF} is the reference temperature during the derating step.

T_{FEEDBACK} is the temperature measured in the electronic board which corresponds to the above-mentioned T.

T_{FEEDBACK} is greater than T₁+δ₁. upon the triggering of the derating.

Following the actuation it remains in the DERATING state for the entire time that the feedback is greater then or equal to T1

The output of the regulator 104 is a power set-point which is added, in an adder node 106, to the electrical power value recorded when the derating P_{IN}(t_{DERATING}) starts, provided by a corresponding block 107.

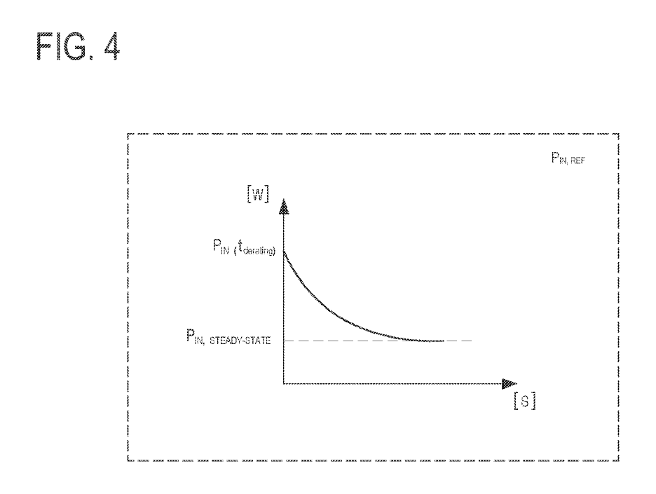

The adder node 106 determines a decreasing set-point for the electrical power P_{IN,REF}, illustrated, for example, in FIG. 4, up to a value P_{IN,STEADY-STATE}.

This set-point is provided at the input, in the case DERATING ON, at the adder node 102.

P_{IN,REF} will settle at a steady state value when the output of PI_{TEMP} stops evolving, that is, when the temperature error (T_{DERATING,REF}−T_{FEEDBACK})=0.

During the derating LIM_{POWER,LOW}=−(EIFreq_{MAX}−EIFreq_{MIN}), that is, the deference between the maximum and minimum electrical frequency allows the actuation in question.

The minus sign allows working with Δfreq<0 and, consequently, to obtain a deceleration linked to the reduction of power governed by PI_{TEMP}.

If the measured temperature is T_{FEEDBACK}<T_{DERATING,REF}, the output of PI_{TEMP} will increase again, increasing the set-point of PI_{POWER}, and producing an acceleration until returning the system to nominal operational conditions, that is, in the NORMAL state.

This invention achieves important advantages.

The control method or algorithm makes it possible to protect the electric and electronic devices against over-temperatures which could occur during operation of the drive unit.

The method is in practice a ‘thermal derating’ process based on the direct control of the maximum temperature permitted for the most critical components, always keeping it at the maximum permissible limit through a continuous control, guaranteeing to the user, in that way, the maximum possible thermal performance.

The above-mentioned control algorithm acts on the ‘directly random’ factor of the over-temperatures inside the motor, that is, the power dissipated, which is directly correlated to the power absorbed by the motor itself, rather than on the ‘indirect’ factor consisting of the motor speed, which, on the other hand, does not feel the effect of absorbed, and therefore dissipated, power variations, induced by phenomena such as the speed dynamics of the vehicle, change of air density due to temperature or altitude, etc.

The control method adjusts the maximum possible operating temperature in a direct and accurate manner through a continuous control of the power absorbed by the motor, which is measurable preferably by processing the voltage and current feedback signals.

Moreover, the control method enables the response, static and dynamic, to be summarised in a completely independent manner, unlike the other processes comprising the overall drive control system.

This differs from a system controlled simply by speed, wherein the drive receives an electrical frequency set-point to rotate, irrespective of the input power.

1. A method for controlling an electric fan comprising an electric motor and electronics for controlling the electric motor, comprising:
a step of controlling the speed of the motor,
the method wherein it comprises
a step of power controlling the motor alternatively to the step of speed controlling, the power controlling step comprising:
a step of monitoring the electrical power P_{IN;FEEDBACK} absorbed by the motor;
a step of regulating the electrical power P_{IN;FEEDBACK} absorbed by the motor, comprising;
a step of applying a variation Δfreq to the electricity supply frequency of the motor as a function of a difference between a power set-point PI_{IN, REF} and the power absorbed by the motor PI_{IN,FEEDBACK}.

2. The method according to claim 1 wherein, in a first operating state of the electric fan, the power set-point PI_{IN, REF} comes from a reference generator (103) which provides to a PI_{Power} regulator a reference signal for varying the electrical power absorbed by the motor P_{IN;FEEDBACK} from a measured value of absorbed power P_{IN}(t_{PMAX,ON}) to a predetermined value P_{MAX}.

3. The method according to claim 2 wherein the regulator PI_{POWER-} is limited at the output between a
a maximum value LIM_{POWER,HIGH} set by default to the difference between a maximum frequency EIFreq_{MAX} corresponding to a maximum power absorbed by the motor during the power control and a maximum frequency EIFreq_{NEN} permitted during the speed control and
a minimum value LIM_{POWER,LOW} set by default to 0; in that way, when in power control the PI_{POWER regulator-} keeps the power of the motor to the predetermined value P_{MAX} varying the electrical frequency between EIFreq_{NEN} and EIFreq_{MAX}.

4. The method according to claim 1, wherein the power set-point PI_{IN, REF} is controlled by a second regulator PI_{TEMP} which reduces the power set-point PI_{IN, REF} starting from an initial value P_{IN}(t_{DERATING}).

5. The method according to claim 4 comprising
a step for setting a maximum nominal operating temperature T₁ of the control electronics;
a step for setting a hysteresis δ₁ on the maximum nominal operating temperature;
a step of monitoring the temperature T of the control electronics;
a step for regulating the temperature T of the control electronics, which starts when the temperature T of the control electronics exceeds the T₁+δ₁, using the step of regulating the electrical power P_{IN;FEEDBACK} absorbed by the motor,
wherein the second regulator PI_{TEMP} has at the input, by means of an adder node, a temperature error T_{DERATING,REF}−T_{FEEDBACK} where:
T_{DERATING,REF} is the reference temperature during the step of regulating the temperature T;
T_{FEEDBACK} is a temperature measured in the control electronics which corresponds to the temperature T, T_{FEEDBACK} being greater than or equal to T₁ during the step of regulating the temperature T, the output of the second regulator PI_{TEMP} being a power set-point which is added, in a second adder node, to the electric power value P_{IN}(t_{DERATING}) recorded when the step of regulating the electric power P_{IN;FEEDBACK} absorbed by the motor starts.
